(19) United States
(12) Patent Application Publication
(10) Pub. No.: US 2012/0102326 A1
(43) Pub. Date: Apr. 26, 2012

(54) Facilitating Secure Communications

(76) Inventor: Nikhil Sanjay Palekar, Arlington, VA (US)

(21) Appl. No.: 13/341,070

(22) Filed: Dec. 30, 2011

Related U.S. Application Data
(63) Continuation-in-part of application No. 13/106,799, filed on May 12, 2011.
(60) Provisional application No. 61/334,574, filed on May 13, 2010.

(51) Int. Cl. H04L 9/32; G06F 15/16

(52) U.S. Cl. 713/168; 709/206

(57) ABSTRACT

The claimed subject matter provides systems and methods for facilitating secure communications. The disclosed systems and methods can include components for receiving and processing user authentication information from users or other systems to selectively provide access to stored information. The stored information may be displayed on or accessed via interfaces that interact with components of the system. An embodiment provides for generating a message request based at least in part on at least one received user input, transmitting the message request to a server device, and receiving a message representation associated with the at least one user input that contains at least one resource identifier.

### REFERENCE TO RELATED APPLICATIONS

This application is a continuation-in-part of U.S. Non-Provisional application Ser. No. 13/106,799, filed May 12, 2011 and entitled Facilitating Secure Communications, which claims the benefit of U.S. Provisional Patent Application Ser. No. 61/334,574, filed May 13, 2010, the entirety of which are incorporated herein by reference.

### TECHNICAL FIELD

This invention relates to the field of secure electronic messaging and communications using computer networks.

### BACKGROUND

Traditional communications systems that operate over shared channels such as the Internet are inherently insecure because they operate using insecure network links and insecure data-transfer protocols. Because these communications channels are not secure, the confidentiality or integrity of the communications information may be compromised while the information is in transit. Some systems designed to provide secure communications do so by exchanging encryption keys, but that process is both cumbersome and ineffective, as all users involved in the communications session have to share some knowledge about each other and have a working technical knowledge of key-exchange systems to implement such a system. Other systems password-protect the message itself; however, the password still has to be communicated separately to the recipient. Still other systems require users to create new accounts for sending and receiving communications messages through the system.

### SUMMARY

Embodiments of the present invention provide a secure communications system that authenticates senders and recipients of communications messages to ensure that the messages are transmitted securely from the sender to the recipient. Each user may be authenticated independently. In an embodiment, at least one of the users already has authentication credentials associated with at least one third-party system that may be used to authenticate the user. Messages sent and received using the messaging system further may be incorporated into the user's existing email account with other message content.

In embodiments, the communications system also may provide a variety of interfaces through which users interact with the system. These interfaces facilitate access to message data after the user has provided valid authentication credentials to the communications system. Thus, a user may specify that a message should expire after a certain amount of time, or a user may permanently delete all related copies or representations of the message if the information contained therein is no longer needed. In one embodiment, the communications system is configured to function like a traditional email server that interfaces with a desktop email client. Users may manage messages and initiate communications through the desktop email client, as with traditional email systems. In another embodiment, the communications system provides a web-based interface for users initiating or responding to communications messages via the communications system. The communications system also may provide account management services for users as part of the user interface.

According to another embodiment, a device may comprise a memory configured to store at least one data packet and a processor operatively coupled to the memory and configured to generate a message request based at least in part on at least one received user input, transmit the message request to a server device, and receive a message representation associated with the at least one user input, where the message representation contains at least one resource identifier.

In another exemplary embodiment, generating a message request comprises identifying message data for transformation. According to another embodiment, the identified message data is based at least in part on at least one stored message. According to another embodiment, identifying message data comprises parsing at least one of a message header or message content. In another embodiment, receiving a message representation comprises receiving a multi-part message comprising at least one markup part wherein the at least one markup part refers to the user input. According to another embodiment, the at least one markup part comprises at least one of XML or HTML content. In another embodiment, the at least one markup part relates to at least one file attachment.

Another exemplary embodiment further comprises transmitting at least one authentication key to the server device. Another exemplary embodiment further comprises rendering at least a first part of the message representation. In another embodiment, the at least one resource identifier is configured to facilitate dynamic rendering of secure content previously included in the at least one user input. According to another embodiment, the at least one resource identifier is configured to be rendered securely as part of a message transmitted non-securely to at least one recipient.

### BRIEF DESCRIPTION OF THE DRAWINGS

FIG. 1 is a block diagram of an exemplary embodiment of a secure communications system.

FIG. 2 is a block diagram of an exemplary embodiment of an authentication module of a secure communication system.

FIG. 3 is a block diagram of an exemplary embodiment of a messaging component of a secure communication system.

FIG. 4 is a block diagram of an exemplary federated communications system in accordance with an embodiment.

FIG. 5 is a flowchart illustrating an exemplary process for managing secure communications.

FIG. 6 is a flowchart illustrating an process for authenticating a user according to an embodiment.

FIG. 7 is a flowchart illustrating a process for processing a content request from a message recipient according to an embodiment.

FIG. 8 is a flowchart illustrating a process for generating a message that facilitates access to secure content according to an embodiment.

FIG. 9 shows a computer network system and environment in accordance with an embodiment.

### DETAILED DESCRIPTION

Embodiments of the present invention are now described with reference to the drawings, wherein like reference numerals are used to refer to like elements throughout. In the following description, numerous specific details may be set forth to provide a thorough understanding of one or more embodiments of the invention, but in some instances embodiments may be practiced without these specific details. In other instances, well-known structures and devices are shown in block diagram form in order to facilitate describing one or more embodiments of the invention.

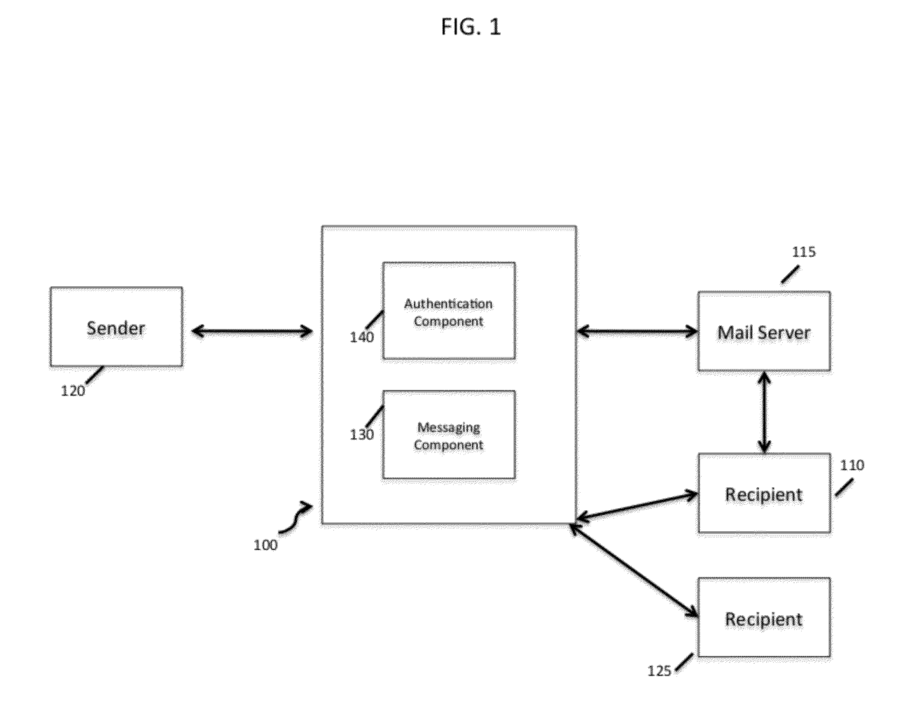

An exemplary communications system 100 is illustrated in FIG. 1. In an embodiment, the communications system 100 facilitates communications between at least one recipient, such as recipient 110 or recipient 125, and one sender 120. In an example, recipient 110 and sender 120 may interact with communications system 100 using mobile computing devices or personal computing devices operatively connected to a computer network, such as the Internet. In an embodiment, the communications system 100 comprises an interface component 130 and an authentication component 140. The system 100 is capable of operating using a variety of standard email and communications protocols including Simple Mail Transport Protocol (SMTP), Internet Access Message Protocol (IMAP), HyperText Transfer Protocol (HTTP), other Simple Authentication and Security Layer (SASL)-based communication protocols, and secure variants thereof that implement the Secure Socket Layer (SSL) or Transport Layer Security (TLS) protocols to encrypt communications between systems. Secure communications occur over a specified port using a specified encryption algorithm to establish a secure communications channel for transmitted information. It is to be understood that components of communications system 100 may be implemented on different computing devices operatively coupled to perform functions, as disclosed herein.

In an embodiment, a messaging component 130 manages communications received and transmitted by the system 100. For example, messaging component 130 may be configured to handle communications messages received from the sender 120. In an embodiment, the messaging component 130 may analyze the contents of the message to classify the communications message. For example, a particular message may include one or more identifiers signaling that the communications message should be classified according to the attached data files included as part of the communications message. In an exemplary embodiment, the messaging component 130 may encrypt the message after receiving it from the sender 120 but before it stores the message in a database. Individual message fields or components may be encrypted separately in embodiments, while entire message objects may be encrypted in other embodiments.

In another embodiment, the messaging component 130 sends a message to the recipient 110 in response to receipt of a communications message from the sender 120 via mail server 115 using an input recipient email address or identity. Mail server 115 may be an external server with which communications system is operatively connected and configured to communicate via a computer network, and mail server 115 may be configured to process email and other network communications as well known in the art. For example, the messaging component 130 may send a notification message to the recipient 110, using the address input for the recipient, which may include an email address or identifier that facilitates determination of a messaging address, that may contain information associated with the sender's original message. In an embodiment, the notification message may include identifying information about the source of the original message and a way for the recipient 110 to access the original message. In another embodiment, the notification message provides access to secure content that may be delivered dynamically if the recipient 110 has already been authenticated by system 100. The messaging component 130 sends the notification message to the recipient 110 via the mail server 115 using traditional protocols for email communications listed herein, such as SMTP, without compromising the security and confidentiality of the original message. Recipient 110 may communicate with mail server 115 using known methods and protocols associated with Internet and email communication to retrieve the notification message. In another embodiment, recipient 125 may be configured to communicate directly with messaging component 130.

The messaging component 130 also provides a messaging and management interface that users may use to view and manage communications. The messaging component 130 may provide different views of the items accessible to the user, and in an embodiment, the messaging component 130 may include various display options that provide different views of content. Also, the messaging component 130 may be configured to display different messaging items differently within the interface. In addition, the messaging component 130 may be configured to display the items in the interface according to saved preferences or input from the user or based on message attributes or message type. Such preferences may pertain to sorting, labeling, or other organizational options. In one embodiment, the recipient 110 may access the individual message associated with his/her notification message without viewing the complete messaging interface. In this manner, the recipient 110 may take various actions in response to the message, including replying, retrieving any attached files, or deleting the message. This list of actions is merely exemplary and not exhaustive of all actions available to the recipient 110 using the interface.

An authentication component 140 authenticates the sender 120 before allowing access to the system. The sender 120 may authenticate with the communications system 100 in various ways, but in an exemplary embodiment, the sender 120 interfaces with the system 100 using a web interface displayed as a web page on a display device connected with the sender's device. In another embodiment, the sender 120 may authenticate with the communications system 100 using an email client software program installed on the sender's device that is configured to communicate securely with the communications system 100. In examples described herein, authentication may be accomplished using a username-password combination, email address, alias, login token, other user information, or some combination thereof, which will be discussed in further detail below. The authentication component 140, thus, establishes a secure connection between the system 100 and the sender 120 before communications data is exchanged. If the sender 120 has been authenticated, the communications system 100 may be configured to process and securely store the message received from the sender 120.

The authentication component 140 also authenticates the recipient 110 before granting access to the sender's original message. In an embodiment, the recipient 110 receives a notification message and attempts to retrieve the original message sent by sender 120. The authentication component 140 requires that the recipient 110 provide valid login credentials before providing access to the content of the sender's original message. In an embodiment, the recipient 110 uses a set of credentials that includes a user name and password, authentication token, alias, or other credential, to authenticate and establish a secure connection between the system 100 and the recipient 110. If the authentication component 140 determines that the recipient 110 has been authenticated, it may provide access to the sender's original message or a representation thereof containing secure content.

In another embodiment, the authentication component 140 determines whether the recipient 110 has been authenticated previously in response to a request for content related to the notification message. For example, a device associated with recipient 110 may request content included in the notification message that is accessible only to users that are already authenticated to access resources associated with system 100. If the authentication component 140 determines that the recipient 110 has been properly authenticated, message content delivered in response to the content request may include secure content. In an embodiment, determining if the recipient 110 has been authenticated includes determining whether valid session information exists related to the recipient user 110. Session information may include cookie data that includes a randomized secret value associated with the user or server-side session data. If authenticated, system 100 may be configured to transform content from its original format into another format that may be transmitted securely as part of a communications message, as will be discussed in further detail below.

As will be discussed in further detail below, the authentication component 140 may accept a number of different forms of credentials that generally allow users to authenticate using existing authentication credentials that were not generated directly by the communications system 100.

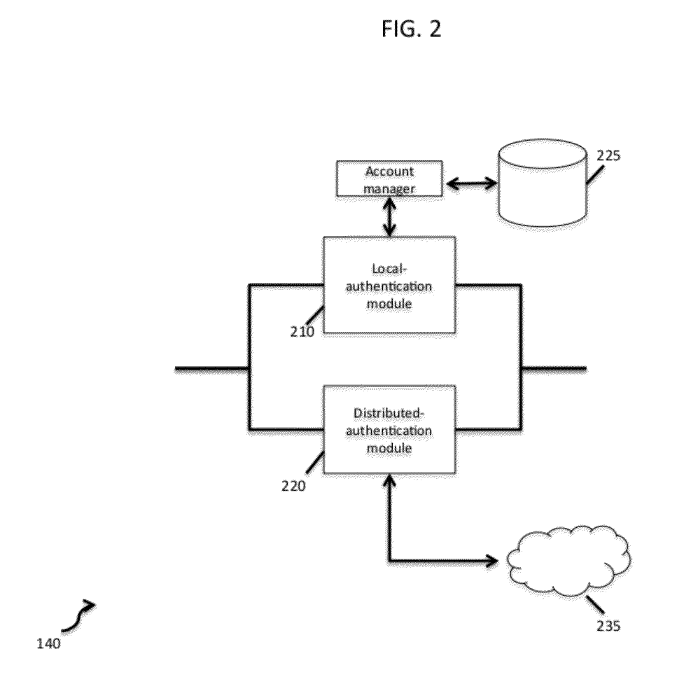

FIG. 2 is a block diagram of an exemplary embodiment of the authentication component 140. The example authentication component 140 includes a local-authentication module (LM) 210, an account manager component 220, and distributed-authentication module (DM) 230. As previously described herein, senders and recipients of communications messages authenticate to authentication component 140 before accessing the resources of the system 100. More generally, any user attempting to access the system 100 provides valid login credentials in order to gain access. The authentication component 140 may automatically use any number of authentication modules to verify the identity of the user attempting to access the system 100. In one embodiment, LM 210 may verify the login credentials provided if they are associated with an account that was created and stored by an account manager component 220. In particular, the account manager 220 may access a database 225 to verify the local credentials provided by the user. In another embodiment, DM 230 verifies the credentials provided from a user even if the user is associated with a system other than system 100. In one embodiment, the user maybe associated with a different system accessible via network 235. For example, a user may provide login credentials as a user-name and password pair, such as “user@externalsite.com” and “password,” and the DM 230 attempts to authenticate the user based on those credentials. In another example, a user may also provide credentials in the form of a login identity. In an embodiment, the DM 230 provides for authentication with one or more other systems that implement an authentication framework. For example, an external system may implement or interface with variants of OpenID, OAuth, LiveID, Kerberos, Lightweight Directory Access Protocol (LDAP), Active Directory, Security Assertion Markup Language (SAML), other SASL-based frameworks, or other authentication frameworks. The DM 230 may interface with one or more external systems to verify the credentials of the user using one of these frameworks. In one embodiment, DM 230 may determine whether one or more authentication frameworks correspond to the authentication credentials supplied by the user and may initiate one or more authentication requests to the identified frameworks. DM 230 may be further configured to process an authentication outcome from an identified authentication framework to complete an authentication process to facilitate access to communications system 100 for the user. In another example, DM 230 may be configured to connect to a server resource, such as an IMAP server to verify authentication information provided by a user. In an example, DM 230 may be configured to access two authentication frameworks to authenticate user credentials. In another example, DM 230 may authenticate with a framework for user authentication and may be configured to log into a second resource to facilitate retrieval of secure content to be transmitted to the user by system 100.

The LM 210 and the DM 230 may communicate with other components within the system 100 or external frameworks using a variety of communications protocols, including protocols discussed previously herein, XML-based protocols such as the Extensible Messaging and Presence Protocol (XMPP), XMLHttpRequest (XHR), or other protocols for interfacing with other systems or authentication resources. The DM 230 also may require additional authentication information before granting the user access to the system 100. For example, the DM 230 may verify the email address associated with the user-name, or the DM 230 may prompt the user for more information. In an embodiment, the DM 230 or the LM 210 may present the user with a challenge that must be answered to complete the authentication process. The challenge may be in the form of one or more questions or prompts that require one or more inputs from the user.

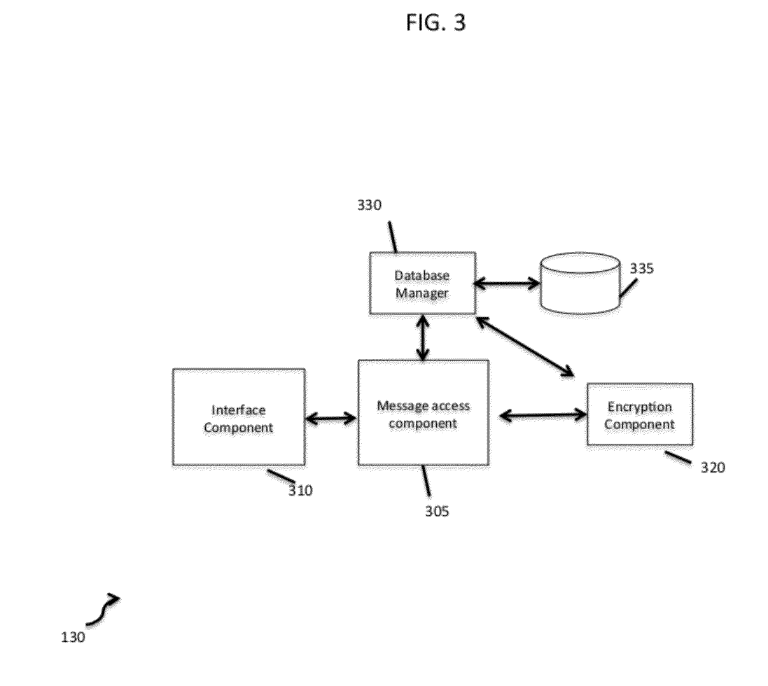

FIG. 3 is a block diagram of an exemplary embodiment of the messaging component 130. This exemplary embodiment of messaging component 300 includes an interface component 310, a message access component (MAC) 305, an encryption component 320, a database manager 330, and database storage units 335. As discussed previously, the messaging component 130 processes incoming and outgoing messages. An interface component 310 handles interactions with users and, in an embodiment, provides a graphical user interface for the user. For example, users may view content using a web-based interface generated by the interface component 310. In one embodiment, an authenticated user attempting to retrieve a message may use a hyperlink displayed as part of the web-based interface to access a particular message. In an embodiment, features of messaging component 130 may be implemented as a code snippet or plugin, such as a script or module written in JavaScript, C#, .NET, or other programming language, configured to operate on a user device to transmit or request and display data from communications system 100. As such, aspects of messaging component 130 may be configured to modify a user interface to perform functions associated with communications system 100.

Interface component 310 may be configured to present the user with an authentication interface before displaying or transmitting secure content. In an embodiment, the authentication interface presented may be a specific challenge question specified by the sender of the message. For example, the sender may have provided at least one challenge question and answer pair associated with the message, and the user attempting to access the message must provide the correct answer to the challenge question before accessing the message. The message information displayed before and after providing correct authentication and/or challenge information may be configured to change. For example, before providing a challenge answer, interface component 310 may be configured to provide information regarding the sender of the message or content along with the challenge inquiry so that the recipient may be able to determine the correct response that provides access to the remaining message content.

In an embodiment, a web interface provided by interface component 310 also allows users to perform various actions on a message displayed by the interface. For example, the user may forward, reply to, or delete a message. In an embodiment, the interface component 310 also may allow the user to compose a new message to be processed by communication system 100.

In addition, the interface component 310 may be configured to display attributes or other information related to the message as part of the web interface. For example, the attributes may include date and time stamps that indicate when the message was sent, processed, accessed, or modified or the IP address or other information about the computer or user from which messages were retrieved. The information also may include attributes associated with any files attached to the message. Further, the interface component 310 also may provide controls via the interface that allow the user to add or remove file attachments or modify the message. For example, the user may modify the contents of the message, change delivery settings, including adding or removing message recipients, or delete the message. If a message has been modified, the interface component 310 may display information about the user(s) associated with the modifications. Such attributes may be graphical indications or text or any combination thereof. In one embodiment, deleting a message may permanently delete all copies of the message, such that messages stored by the communications system 100 that are associated with sending users, receiving users, or both may be removed.

The interface component 310 also enables authenticated users to view and manage previously received or sent communications messages. The interface component 310 may generate various views that arrange messages and associated attributes in an orderly manner. In an exemplary embodiment, the interface component 310 displays communications messages based according to the message type associated with the message. For example, interface component 310 may generate a view of “document” type messages that arranges the messages according to the documents associated with or attached to the message. In this view, the interface component 310 may display the attributes or message tag elements with the communications message so that the user may easily access the information.

In addition, the interface component 310 allows the user to specify data-retention policies. In one embodiment, the interface component 310 allows the user to specify a default setting that should be applied to messages created by the user. For example, the user may specify that the default data-retention rule should be to save all messages indefinitely. The user also may specify data-retention rules for individual messages, including an expiration time for the message or an event that causes the message to be purged. In one example, the user may specify that a particular message should be removed two days after the recipient has viewed the message.

In an embodiment, the interface component 310 may retrieve and access message data using a MAC 305. The MAC 305 communicates with interface component 310, encryption component 320, and external client interfaces using communications protocols, as described previously. In an embodiment, the MAC 305 facilitates communications between the interface component 310 and other components of the system 100 using secure variants of IMAP, SMTP, or other protocols. In addition, the MAC 305 may use these or other protocols to facilitate communications between the system 100 and external email clients that users may use for creating and sending communications. In an embodiment, the MAC 305 facilitates communications between an email client, such as Microsoft Outlook or Mozilla Thunderbird or an Internet browser-based client, and the system 100 using secure variants of IMAP, SMTP, HTTP, or scripting languages and libraries that implement communication protocols. In an example, JavaScript jQuery scripting functions may be implement to facilitate such communications. In embodiments, MAC 305 may be configured to provide message data, such as email header information and other limited information about the message contents, to the email client if such information is to be cached for local searching.

MAC 305 also may be configured to interface with an existing mail server to facilitate access to messages associated with a particular user. In an embodiment, MAC may receive a query from a traditional mail server in response to a request for message content by a user. The query may include message identification information and user authentication to retrieve secure message content via MAC 305 using an Application Programming Interface (API). An API associated with MAC 305 may be configured to process one or more messages for transmission via various network transmission protocols discussed herein based on identification information, such as a unique user identifier or email address. Secure message content related to one or more users may be accessible from a local database or file system or may be retrieved from an operatively coupled, remote database, data storage system, or external resource to which system 100 may connect securely.

In another embodiment, MAC 305 maybe configured as a code snippet, such as a JavaScript plugin, configured to update existing message information stored by one or more email servers associated with a user. In another embodiment, MAC 305 may connect to an IMAP server associated with an email account associated with a user. MAC 305 may be configured to scan for content using keywords, heuristics, or other query parameters to identify messages that may contain confidential information that should be stored securely. In an example, for identified messages, MAC 305 may generate a variant of the message that contains at least one identifier associated with the secure content without the secure content itself. For example, a message variant may include one or more HTML-enabled references or resource identifiers that allow the secure content to be viewed by the user only after the user has been authenticated. As such, the confidential information has been removed from the stored version of the message but still may be displayed dynamically and securely to the user upon access by reference to the HTML-enabled references or resource identifiers. In another example, MAC 305 may generate a new message containing such modifications to remove confidential content to replace the existing message stored by the mail server.

The MAC 305 also may facilitate access to individual messages requested by the email client over a secure connection established using the secure protocols, such as those discussed previously. In one example, communications messages are not stored locally by the email client. Instead, the MAC 305 transfers communications messages to the user's email client after receiving a request from the user to retrieve or access the communications message(s). In addition, the MAC 305 may facilitate access to content dynamically based on security, user, and/or authentication settings. In particular, MAC 305 may be configured to provide message content in a form that cannot be copied easily or saved by the retrieving user. This feature may be used for a number of reasons, including confidentiality and security concerns if the contents of the message were saved by the retrieving user. For example, message content may be transformed into image data, encrypted content, or encoded content that may be transmitted securely from communications system 100 to the user using one or more secure protocols, as discussed herein.

In an embodiment, message content may undergo multiple transformations from raw data or database information into an output format. In one example, unformatted data may be transformed into mark-up content, such as XML or HTML content that may be processed and/or rendered by communications system 100. The processed or rendered mark-up content may be further transformed into content in another format, such as image data or encoded data. In an embodiment, multiple content items in one or more formats may be generated as part of a transformation of the stored data. In another embodiment, stored content data may be formatted in an encoded or rendered file format, such as a Portable Document Format (PDF) file, and MAC 305 may be configured to transform the content data into a mark-up language format before performing additional transformations or outputting the content to the user. MAC 305 may also be configured to transform the original stored content from a variety of file or encoding formats directly into a second format that may be output securely to the user. In another embodiment, the MAC 305 facilitates communication between the interface component 310 and the encryption component 320.

In addition, the MAC 305 may be configured to facilitate searching for messages by authenticated users via either an email client or the web interface. In an embodiment, the MAC 305 facilitates searching for matching communications messages based on keywords, message status, date, or message attributes. For example, the user may search for all messages created within the last week that remain unread by the recipient. In an exemplary embodiment, the MAC 305 may receive search terms from a user interacting with the system 100 via a secure connection established through an email client. Message headers and other limited information associated with messages may be cached by the email client, but the MAC 305 transmits messages matching the search query to the email client over the secure connection in accordance with the techniques previously described herein. MAC 305 may be configured to selectively or fully decrypt message content, in connection with encryption component 320, before searching for matching content. In another embodiment, the MAC 305 receives a request for message data based on a user's interaction with a web interface. The searching described herein to identify messages may be accomplished by system 100 using well-known techniques.

Interface component 310 and MAC 305 also may facilitate sending or replying to secure messages from a user's existing messaging interface, such as a web-based email application or communications application. In an example, MAC 305 is configured to modify an existing interface by modifying, adding, or deleting icons, buttons, or functions to enable secure transmission of messaging content. In an embodiment, MAC 305 may include a code snippet or plugin configured to be loaded in an Internet browser application, such as Mozilla Firefox, Google Chrome, or other Internet browsers. In another embodiment, MAC 305 may be configured to be loaded within an email interface of a web-based or installed application. In embodiments, MAC 305 may be configured to provide one or more interface controls, such as a “Send Secure” button, icon, or other interface element that may be used to transmit a secure message via communications system 100. MAC 305 also may facilitate cryptographic transmission and receipt of messages using S/MIME, PGP or other Public Key Infrastructure (PKI)-based cryptographic solutions. In an embodiment, MAC 305 and encryption component 320 may provide encryption key or certificate data associated with one or more recipients or associated with system 100 to facilitate cryptographic transmission of message data.

The encryption component 320 may be configured to encrypt and decrypt messages processed by the communications system according to a default encryption setting or user-specified settings. Encryption algorithms used in processing messages may be any one of the many algorithms well known in the art, including symmetric algorithms and asymmetric algorithms. In one embodiment, the encryption component 320 may automatically process and encrypt received data and transfer the encrypted data to the database manager 330. For example, encryption component 320 may determine an encryption key, secret, initialization vector, or other algorithm configuration information based on specific information associated with the information to be encrypted or decrypted without user input of key data or encryption information. If an encryption key was used to encrypt message content transmitted between a user and system 100, encryption component 320 may be configured to decrypt the message before further processing occurs. In another example, the encryption component 320 also may be configured to apply one or more user-defined settings to message data when processing messages. In an embodiment, the user-defined settings may specify the form of user-defined encryption, if any, used by the encryption component 320 and may include an encryption key, salt, or other credential supplied by the user that should be used to encrypt the data. Where the user has supplied encryption information to encrypt data, additional information may be required from the sender or recipient to decrypt the data. In an embodiment, user-specified settings may be applied in addition to one or more encryption processes applied by system 100.

The database manager 330 may be configured to provide secure storage for user and communications message information sent and received by the system 100. In particular, the database manager 330 interacts with encryption component 320 and interface component 310 to securely store information. For example, the encryption component 320 may provide the database manager 330 with rotating encryption information used to encrypt data. In an embodiment, the encryption information supplied by encryption component 320 may relate to a salt or key associated with one or more database items. In another embodiment, the encryption information may relate to the algorithm to be used. Also, the database manager 330 may oversee the operation of one or more database storage units 335 configured to store communications information. In an embodiment, stored communications information is distributed across multiple database units to facilitate access to the information stored therein. In addition, the database manager 330 may facilitate encryption of one or more database storage units 335 using techniques well known in the art with encryption component 320. In an embodiment, the database manager 330 may receive one or more encrypted messages then encrypt one or more database storage units 335 using a plurality of encryption keys. The encryption keys used to encrypt messages may be symmetric or asymmetric. For example, the database manager 330 may have a public-private key pair to encrypt information, where access to the private key is only available for certain processes running under the control of the database manager 330. In another embodiment, the encryption component 320 may encrypt data received from the database manager 330 and may transmit the encrypted data back to database manager 330. In addition, the database manager 330 may interact with the one or more database storage units 335 using, for example, Structured Query Language (SQL).

In one embodiment, database storage units 335 may be implemented as one or more storage databases that include relational and non-relational, NoSQL databases that are accessed using SQL and various programmatic querying techniques. Embodiments may include some combination of database types that may include relational databases that provide indexing for a non-relational database implementation, such as MongoDB or other similar database implementations.

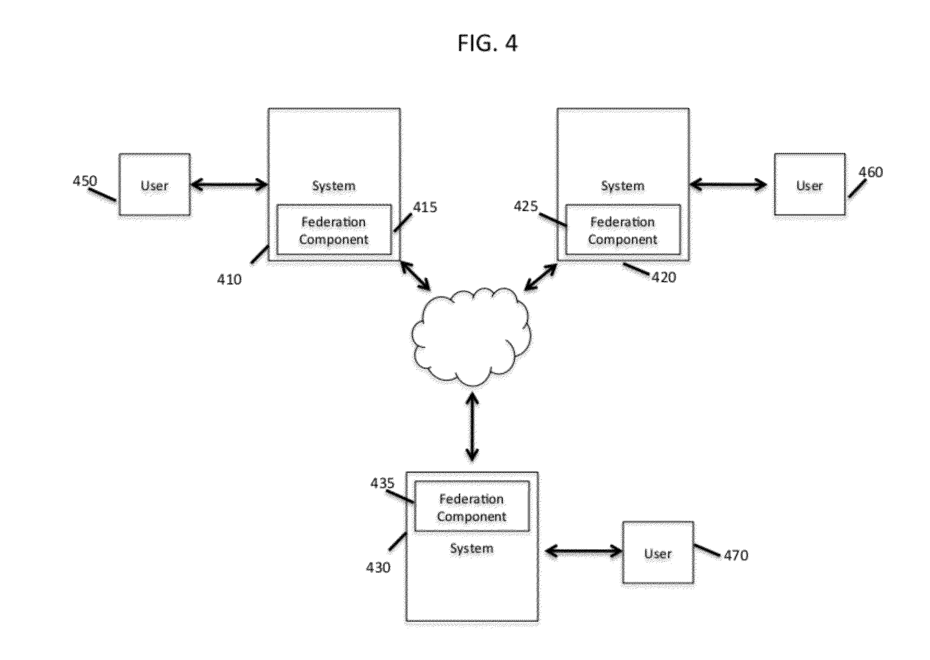

FIG. 4 illustrates an example of a federated system design in accordance with an embodiment of the present invention. The system 100 described above may be one of a plurality of systems, depicted herein as systems 410, 420, and 430, that are able to communicate over data networks. Such systems may be federated to provide a network of trusted systems that provide secure access to users' messages. In one embodiment, systems 410, 420, and 430 provide shared message access to users attempting to access messages stored on one or more of the systems. Federation components 415, 425, and 435 of systems 410, 420, and 430, respectively, handle inter-system communications for authentication and management. Authentication and management may be centralized, where one system in the federated network is designated as the leader, or may be distributed among the systems in the federated network.

In an example, user 450 may have an account associated with the system 410, but certain messages to which the user 450 desires access may be located on the system 420. The systems 410 and 420 may exchange data using their respective federation components 415 and 425, which may communicate using secure protocols, such as those discussed previously herein and/or other secure XML-based communication protocols. The systems 420 and 430 provide access to messages without storing the message on both systems. More specifically, in one embodiment the system 420 may receive a message from user 460 and store and process that message according to the techniques described herein. When user 470 attempts to retrieve the message from his/her system 430, the system 420 facilitates access to the message because it is federated with the system 430 via an API or request in one of the protocols discussed herein. In an embodiment, federation component 435 may send a message request to system 420 regarding a message that user 470 wants to retrieve via an API or request using the secure protocols discussed herein. In an embodiment, the request may also include authentication data related to the user 470 or system 430. The request may be verified using authentication information, such as a token, key, or other authentication information, or one or more Access Control Lists (ACLs) associated with systems 420 and/or 430 and/or individual users. In an example, a message may include one or more unique IDs or references associated with one or more ACLs, whereby the federation component 425 may verify authentication or ID information associated with the user and/or message to determine whether access should be granted to stored data. The federation component 425 handles the request and interacts with other components of the system 410 to determine whether a matching message is stored locally. If a matching message is found, federation component 425 may provide access information to the federation component 435 to facilitate the user's 470 access to the stored information. In this manner, information storage need not be duplicated between trusted systems, but the user 470 receives the requested information without any indication that the information was retrieved from the system 420, not directly from system 430.

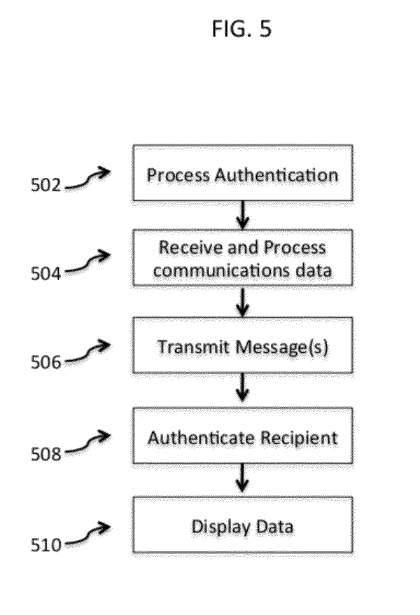

FIG. 5 depicts a method for managing secure communications in accordance with an embodiment of the present invention. At 502, the communications system processes the authentication elements provided by the user. In an embodiment, the system may process authentication elements, such as a user name, email address, password, or other identifier from a user. In an embodiment, authentication elements may be received through a web interface. In another embodiment, the authentication elements may be received from a software application, such as an email client, configured to connect with the communication system using secure communications protocols, such as those discussed herein. In processing the authentication elements, the system may communicate with third-party systems that support one or more third-party authentication frameworks, but the system also may verify the authentication elements locally. In an exemplary embodiment, the system may use one or more third-party authentication frameworks, such as those discussed previously herein, to verify the authentication elements, receiving authentication status or authentication token information or data from the authentication frameworks.

At 504, the communications system receives and processes communications data from the user. For example, the system may receive data packets related to a communications message. The data packets may be received using secure protocols such as those discussed herein above. In processing the data packets, the communications system may encrypt and store data in at least one operatively connected database.

At 506, the communications system transmits at least one communications message to at least one recipient. In an embodiment, the communications system may transmit a notification message to the at least one recipient. The notification message may be transmitted via a messaging protocol, such as those discussed previously herein. In another embodiment, the communication system may transmit a communications message containing secure content or content that may be configured to contain secure content.

At 508, the communications system authenticates the recipient of the message. In an exemplary embodiment, the system receives authentication credentials in the form of a user name and password combination that the communications system uses to authenticate the recipient if the recipient was not previously authenticated. The communications system may communicate with third-party systems to process the authentication credentials as part of its authentication step as discussed previously.

At 510, the communications system provides secure data elements to the recipient. In one embodiment, the communications system may display an email message as an element of a graphical user interface displayed as content in an Internet browser application on the recipient's computer. For example, transmitted secure message content may be automatically integrated with other content as part of the graphical user interface in the Internet browser without additional software. Content also may be integrated using a code snippet, such as a JavaScript, .NET, C#, or other language script, configured to communicate with the communications system to retrieve the secure data and display the secure content as part of the graphical user interface in other embodiments. In still another embodiment, the communications system 100 transmits secure data elements to be contained within an existing communications message displayed in an email or messaging client application.

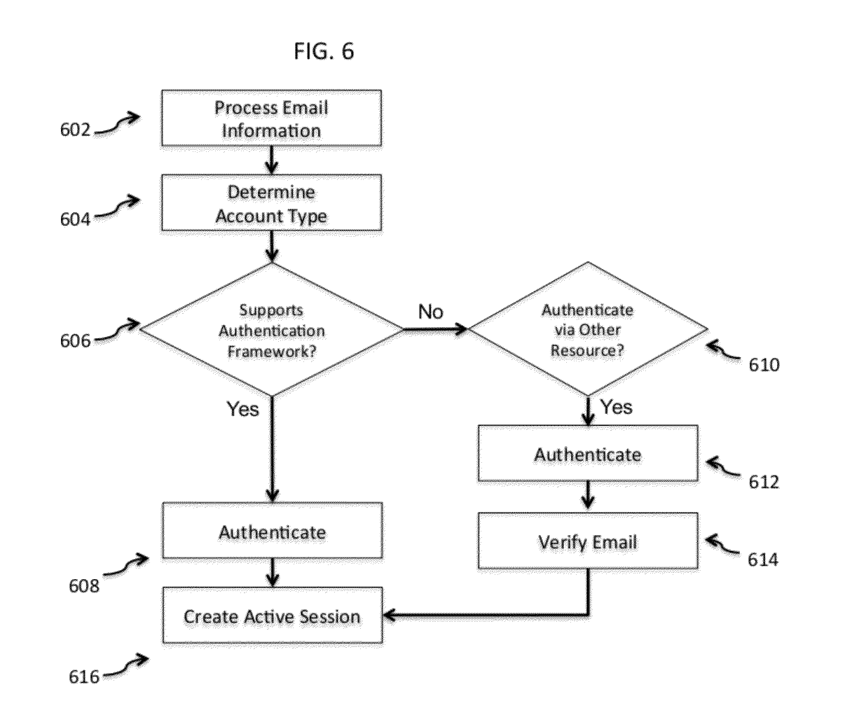

FIG. 6 shows a method for authenticating a user according to an embodiment. At 602, the authentication component 140 receives or processes information associated with a user's email address or identifier, which may include one or more user inputs, received request information, or stored information associated with one or more communications messages processed or stored by communications system 100.

At 604, the authentication component 140 determines the account type based on the user information provided. In an example, if an email address received from a user is user@example.com, authentication component 140 may be configured to parse the received input into a user string and domain string to facilitate authenticating the user. Similarly, authentication component 140 may determine related authentication frameworks based on one or more identifiers associated with the provided user information. In embodiments, the user string may be used to authenticate the user. In other embodiments, an additional received username may be used to authenticate the user. In determining the account type and parsing the input, authentication component 140 may be configured to determine whether authentication may be accomplished via one or more authentication frameworks or whether the user need be authenticated by logging into a remote resource, using the provided user information.

At 606, if the domain associated with the user supports authentication via authentication frameworks, the process proceeds to 608 where authentication component 140 is configured to authenticate the user. In an example, domains implementing OpenID for delegated authentication allow the user to enter authentication information then provide an authentication token or string to authentication component 140 indicating whether the user has been properly authenticated. In another example, domains implementing other authentication frameworks or single sign-on mechanisms may generate authentication information associated with the user that may be used to assert or verify an authentication status. If the user is properly authenticated using one or more authentication frameworks, the process proceeds to 616.

If the domain associated with the account does not support available authentication frameworks, the process proceeds to 610. At 610, authentication component 140 determines whether the user may be authenticated using another resource associated with the domain. In an embodiment, authentication component 140 may determine or locate an address or resource identifier associated with a domain resource, such as an IMAP server.

At 612, if a domain resource is available to provide user authentication, authentication component 140 may use user authentication information to access the domain resource to verify that the credentials are valid and are associated with the email address used by the user. In an embodiment, authentication component 140 may initiate a secure connection over TLS with the IMAP server associated with the user's login information. Upon completion of the TLS negotiation, authentication component 140 may use the user's login credentials to authenticate the user to the IMAP server using an Authenticate or Login command.

At 614, if the login to a public server resource is successful, authentication component 140 may be configured to verify the email address associated with the login information. In an embodiment, authentication component 140 may identify one or more messages included in the available mailbox to determine whether the email address associated with the account corresponds to the email address stored by communications system 100 for the user.

At 616, if the user authentication was successful, authentication component 140 creates an active session associated with the user. In an embodiment, authentication component 140 creates a new session based on an identity token or authentication status received from the authentication resources indicating that the user was properly and securely authenticated. In another embodiment, authentication component 140 creates a new session based on a successful login to a server resource using user-supplied login credentials.

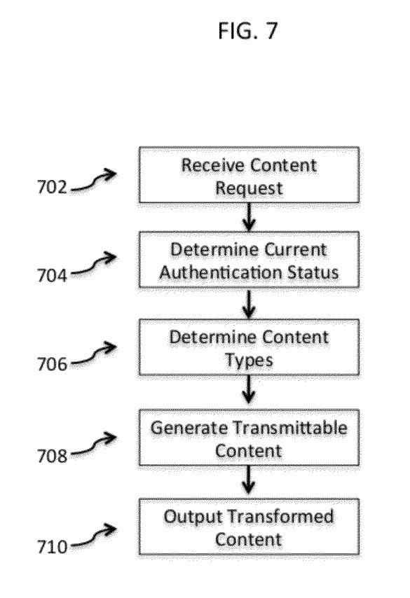

FIG. 7 shows a method of processing a content request from a message recipient in accordance with an embodiment. At 702, messaging component 130 receives a content request that includes one or more content identifiers transmitted non-securely or in traditional messages. In an example, a content request may be for XML, HTML, or script object content included in an email message transmitted over a computer network from a sender to a recipient. Content identifiers may include any number of markup or script tags associated with secure content stored or processed by communications system 100.

At 704, messaging component 130 determines a current authentication status associated with a user. In an embodiment, messaging component 130 is configured to determine user information, such as a user identifier, associated with the requested content and is configured to verify whether the user status indicates that the user has already been fully authenticated. In another embodiment, messaging component 130 determines whether the content request includes one or more user identifiers that may be used to indicate an authentication status, such as an authentication token that may be processed to validate the current request.

At 706, messaging component 130 determines one or more content types associated with the requested data. In an embodiment, messaging component 130 determines the format in which message data, such as message text, message attachments, and other message data and content associated with the request, is stored.

At 708, messaging component 130 generates transmittable content, based at least in part on the format associated with the data request. In an embodiment, generating transmittable content may include one or more data transformations, data rendering, or data translation from one or more formats into one or more requested formats. In another embodiment, the requested format may be different from the format of the stored content format. In various examples, content request formats may include HTML, XML, script content, or combinations thereof.

At 710, messaging component 130 outputs the transformed content securely in a format corresponding to the request received from a device associated with the recipient. As discussed previously herein, messaging component 130 may be configured to output data over various secure protocols.

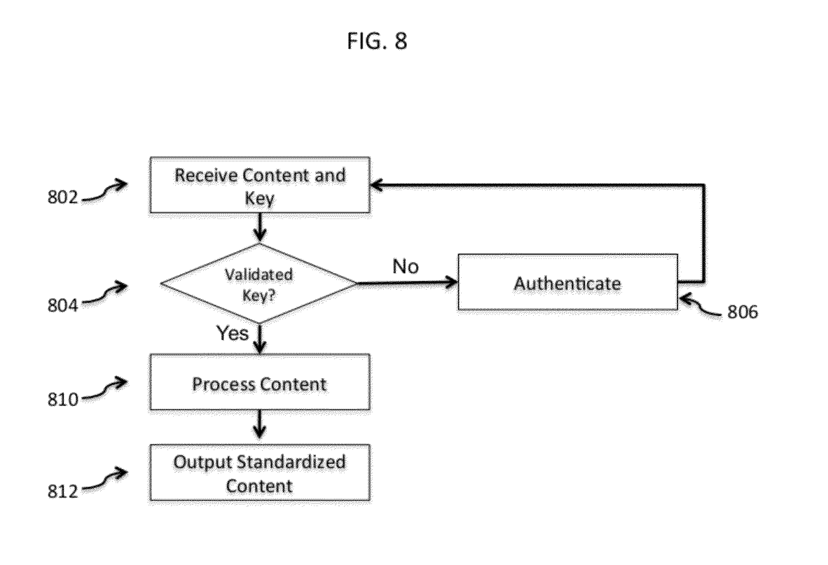

FIG. 8 shows an exemplary process of generating a message that facilitates access to secure content. At 802, messaging component 130 receives message content and an authorization key or credentials from a client interface. In an example, message content may include message data from an email application. Such content may be received in part based on a user input, such as clicking a “Send” or “Secure” button or interface object configured to be displayed in an interface for the user.

At 804, system 100 verifies the received authentication credentials provided by the user. In an example, verifying authentication credentials may include verifying an authentication key or other authentication data, as discussed previously herein. If the authentication data is properly verified, using techniques discussed previously, the process continues to 810, otherwise the process proceeds to 806.

At 806, an output may be generated for the user or application connected to system 100 to provide authentication information to allow the user or connected application to authenticate using various authentication credentials, as described previously in FIG. 6 and throughout the specification. In an embodiment, the output may include an error message or prompt related to the specific authentication data supplied or may include a prompt to re-enter the authentication information. If authentication information is provided, the process may return to 802.

At 810, messaging component 130 processes message content into transformed content that may be configured to include at least one content resource identifier. In an example, one or more HTML or XML standardized markup tags may be generated to provide a reference to one or more parts of the secure message content stored by or accessible via system 100.

At 812, messaging component 130 outputs the transformed content. In an example, the output may be configured to be inserted into a message displayed in an interface of a client application or browser interface. The client application may be configured to display the message, including the standardized content in a rendered or non-rendered format. In another example, the output may be configured to be transmitted in the standardized form as part of a standard message directly to or via a messaging server for transmission to one or more indicated recipients.

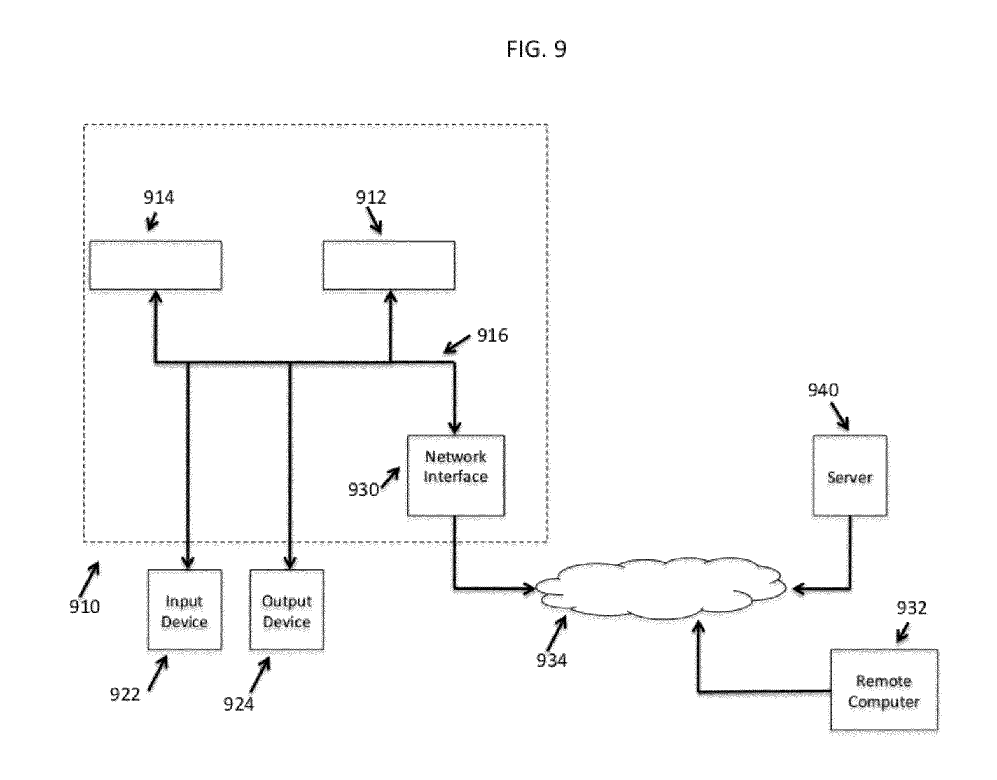

FIG. 9 illustrates a computer system implementing aspects of the present invention. In particular, computer 910 can be any computing device, such as a desktop computer, laptop computer, tablet device, or mobile device, configured to connect to the Internet. The computer 910 includes a processing component 912, memory 914, and a system bus 916. It is to be understood that the processing component 912 may comprise various processor designs that may include multiple processors. The system bus 916 provides a connection between system components, such as the processing component 912 and memory 914. The system bus may be any one of a number of designs that are well known in the art. The memory 914 may include any combination of volatile and non-volatile memory types of random access memory (RAM) and read-only memory (ROM) and other computer-readable media operable to store and facilitate transfer of computer-executable instructions and computer data, such as the software code associated with the present invention. The computer 910 also includes input devices 922 and output devices 924. The input devices 922 may include interaction devices such a keyboard, mouse, or touchpad configured to communicate with components of computer 910 via at least one input/output controller or interface. The output devices 924, such as a monitor, may display elements related to the functions of the present invention in a graphical format.

The computer 910 also includes a network interface 930, which is any interface suitable to physically link computer 910 with various networks to allow the computer 910 to connect to remote computers, such as remote computer 932. The network interface 930 may be configured to connect to various networks 934, such as local-area networks (LAN) and wide-area networks (WAN) using various communications technologies. In particular, the network interface 930 may utilize wired and wireless network protocols to connect to various networks and remote systems connected thereto. The computer 910 may be operably connected to at least one server 940 via the network interface 930 and the networks 934 and may exchange data packets therewith. Such data packets may be related to data stored or processed by the server(s) 940 that may be further processed or otherwise utilized by the computer 910. Server(s) 940 may be configured to include similar features as computer 910 with regard to components and functionality, as would be well understood to one having ordinary skill in the art. Computer 910 and server(s) 940 may be servers, workstations, personal computers, or other computing devices configured to communicate via network 934. The hardware architectures of other computing devices are to be used by way of examples, individually or networked together, and are materially similar to that of computer 910, and will therefore not be further detailed.

The flowchart and block diagrams in the figures illustrate the architecture, functionality, and operation of some possible implementations of systems, method, and computer program products according to various embodiments. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending on the functionality involved.

The invention can take the form of an entirely hardware embodiment, an entirely software embodiment, or an embodiment containing both hardware and software elements. In a preferred embodiment, the invention is implemented in software as computer executable instructions, which includes but is not limited to firmware, resident software, microprocessor code, etc.

Furthermore, the invention can take the form of a computer program product accessible from a computer-usable or computer-readable medium providing program code for use by or in connection with a computer or any instruction-execution system. For the purposes of this description, a computer-usable or computer-readable medium can be any tangible apparatus that can contain, store, communicate, propagate, or transport the program for use by or in connection with the instruction execution system, apparatus, or device.

It will be appreciated that a novel communications system and method have been described for enabling parties to transmit and receive information in a manner that preserves confidentiality and ensures security. The examples described herein are merely some embodiments of the present invention. These examples are not intended to limit the scope of the present invention, since it is not possible to enumerate every possible combination of components or methodologies associated with a description of the present invention. Those having ordinary skill in the art may recognize that other combinations or arrangements of the present invention are possible, and the present invention is meant to include all such variations. The invention as described herein contemplates all such embodiments as may come within the scope of the following claims and equivalents thereof. Furthermore, where the term “includes” has been used herein, either in the claims or in the detailed description, it is intended to be equivalent to the term “comprising” when that term is used as a transitional word in a claim.

What is claimed is:

1. A device for facilitating secure communications, comprising:
a memory configured to store at least one data packet; and
a processor operatively coupled to the memory and configured to:
generate a message request based at least in part on at least one received user input;
transmit the message request to a server device; and
receive a message representation associated with the at least one user input, wherein the message representation contains at least one resource identifier.

2. The device of claim 1, wherein generating a message request comprises identifying message data for transformation.

3. The device of claim 2, wherein the identified message data is based at least in part on at least one stored message.

4. The device of claim 2, wherein identifying message data comprises parsing at least one of a message header or message content.

5. The device of claim 1, wherein receiving a message representation comprises receiving a multi-part message comprising at least one markup part, wherein the at least one markup part refers to the at least one user input.

6. The device of claim 5, wherein the at least one markup part comprises at least one of XML or HTML.

7. The device of claim 5, wherein the at least one markup part relates to at least one file attachment.

8. The device of claim 1, further comprising transmitting at least one authentication key to the server device.

9. The device of claim 1, further comprising rendering at least a first part of the message representation.

10. The device of claim 1, wherein the at least one resource identifier is configured to facilitate dynamic rendering of secure content previously included in the at least one user input.

11. The device of claim 10, wherein the at least one resource identifier is configured to be rendered securely as part of a message transmitted non-securely to a recipient.

12. A method for facilitating secure communications, comprising:
generating, using a first device, a message request based at least in part on at least one received user input;
transmitting the message request to a server device; and
receiving, at the first device, a message representation associated with the at least one user input, wherein the message representation contains at least one resource identifier.

13. The method of claim 12, wherein generating a message request comprises identifying message data for transformation.

14. The method of claim 12, wherein receiving a message representation comprises receiving a multi-part message comprising at least one markup part, wherein the at least one markup part refers to the at least one user input.

15. The method of claim 14, wherein the at least one markup part comprises at least one of XML or HTML.

16. The method of claim 12, further comprising transmitting at least one authentication key to the server device.

17. The method of claim 12, further comprising rendering at least a first part of the message representation.

18. The method of claim 12, wherein the at least one resource identifier is configured to facilitate dynamic rendering of secure content previously included in the at least one user input.

19. The method of claim 18, wherein the at least one resource identifier is configured to be rendered securely as part of a message transmitted non-securely to a recipient.

20. A non-transitory computer-readable having computer-readable instructions stored thereon, the instructions comprising:
instructions to generate a message request based at least in part on at least one received user input;
instructions to transmit the message request to a server device; and
instructions to generate a message representation associated with the at least one user input, wherein the message representation contains at least one resource identifier.
